(19) United States
(12) Patent Application Publication
(10) Pub. No.: US 2021/0062541 A1
(43) Pub. Date: Mar. 4, 2021

(54) TUBULAR LOCK AND METHOD FOR ASSEMBLING THE SAME

(71) Applicant: ABA UFO INTERNATIONAL CORP., New Taipei City (TW)

(72) Inventor: MIKO LEE, NEW TAIPEI CITY (TW)

(21) Appl. No.: 16/556,598

(22) Filed: Aug. 30, 2019

(51) Int. Cl. E05B 27/00; E05B 55/00

(52) U.S. Cl. CPC E05B 27/0017; E05B 55/005

(57) ABSTRACT

A tubular has a hollow housing, a lock core, a pin seat, multiple pin assemblies, and a covering assembly. Multiple upper through holes are separately formed through a head portion of the lock core. Multiple lower through holes are separately formed through the pin seat and align with the upper through holes of the lock core respectively. An assembler assembles the housing, the lock core, and the pin seat in a preliminary assembling step, then puts the pin assemblies into the upper through holes and the lower through holes from a rear end face of the pin seat in a detail assembling step, and then covers the lower through holes with the covering assembly in a packaging step. The pin assemblies do not fall from the upper through holes and the lower through holes easily. The tubular lock has simplified assembling steps and lowered difficulty of assembling.

### BACKGROUND OF THE INVENTION

### 1. Field of the Invention

The present invention relates to a tubular lock that is easy to assemble, and a method for assembling the tubular lock.

### 2. Description of the Prior Art(s)

A conventional tubular lock comprises a hollow housing, a lock core, a pin seat, and multiple pin assemblies. The lock core is mounted in the housing and has a head portion and a mounting portion. Multiple through holes are separately formed through the head portion and are annularly arranged on the head portion. The mounting portion axially protrudes from a rear end face of the head portion and toward a rear portion of the housing. The pin seat is mounted around the mounting portion of the lock core and is securely connected with the housing. Multiple blind holes are separately formed in a front end face of the pin seat and are annular arranged on the pin seat. The blind holes align with the through holes respectively. The pin assemblies are mounted in the through holes and the blind holes that correspond to each other respectively. Each of the pin assemblies includes an upper pin, a resilient element, and a lower pin.

When assembling the conventional tubular lock, an assembler puts the upper pins of the pin assemblies into the through holes respectively and puts the resilient element and the lower pin of each pin assembly into a corresponding one of the blind holes. Then the assembler takes the lock core and the pin seat with his two hands respectively and allows the mounting portion of the lock core to protrude through the pin seat, i.e. allows the pin seat to be mounted around the mounting portion. Afterwards, the assembler put the lock core as along with the pin seat into the housing and securely connects the housing and the pin seat with a fastening pin.

In order to prevent the upper pins from falling from the lock core and prevent the resilient elements and the lower pins from falling from the pin seat, the assembler has to keep the through holes and the blind holes parallel with the ground when assembling the lock core and the pin seat. Once the lock core or the pin seat tilts, even slightly, the upper pins or the lower pins and the resilient elements would fall from the lock core or the pin seat. Hence, assembling the conventional tubular lock relies heavily on stability of the hands of the assembler and the assembler's ability to perform fine motor. Accordingly, assembling the conventional tubular lock requires the expenditure of effort and also requires the expenditure of time to inexperienced assemblers.

To overcome the shortcomings, the present invention provides a tubular lock and a method for assembling the tubular lock to mitigate or obviate the aforementioned problems.

### SUMMARY OF THE INVENTION

The main objective of the present invention is to provide a lock tubular that has a hollow housing, a lock core, a pin seat, multiple pin assemblies, and a covering assembly.

The lock core is mounted in the housing and has a head portion, a mounting portion, and multiple upper through holes. The mounting portion axially protrudes from a rear end face of the head portion and toward a rear portion of the housing. The upper through holes are separately formed through the head portion and are arranged around the mounting portion. Each of the upper through holes is defined through a front end face of the head portion and the rear end face of the head portion.

The pin seat is mounted around the mounting portion of the lock core, is securely connected with the housing, and has multiple lower through holes. The lower through holes are separately formed through the pin seat, are arranged around the mounting portion, and align with the upper through holes of the lock core respectively. Each of the lower through holes is defined through a front end face of the pin seat and a rear end face of the pin seat.

Each of the pin assemblies includes an upper pin mounted in the upper through holes respectively, a lower pin mounted in the lower through holes respectively and positioned toward the front end face of the pin seat, and a resilient element mounted in the lower through holes respectively and positioned toward the rear end face of the pin seat.

The covering assembly is securely mounted in the rear portion of the housing and covers the rear end face of the pin seat to cover the lower through holes of the pin seat.

With the lower through holes formed through the front end face and the rear end face of the pin seat, an assembler is able to assemble the housing, the lock core, and the pin seat in a preliminary assembling step. Then the assembler puts the upper pins, the lower pins and the resilient elements of the pin assemblies into the upper through holes and the lower through holes from the rear end face of the pin seat in a detail assembling step. Afterwards, the assembler covers the lower through holes with the covering assembly in a packaging step.

During the assembling steps, the upper pins, the lower pins and the resilient elements do not fall from the upper through holes and the lower through holes easily. Accordingly, the tubular lock of the present invention has simplified assembling steps and lowered difficulty of assembling. Even an inexperienced can also assemble the tubular lock quickly, and thus manufacturing cost of the tubular lock is lowered.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a tubular lock in accordance with the present invention;

FIG. 2 is an exploded perspective view of the tubular lock in FIG. 1;

FIG. 3 is a cross-sectional side view of the tubular lock in FIG. 1;

FIG. 4 is an exploded perspective view of a second embodiment of a tubular lock in accordance with the present invention;

FIG. 5 is a cross-sectional side view of the tubular lock in FIG. 4;

FIG. 6 is an exploded perspective view of a third embodiment of a tubular lock in accordance with the present invention;

FIG. 7 is a cross-sectional side view of the tubular lock in FIG. 6; and

FIG. 8 is a flow chart of a method for assembling a tubular lock in accordance with the present invention.

### DETAILED DESCRIPTION OF THE PREFERRED EMBODIMENTS

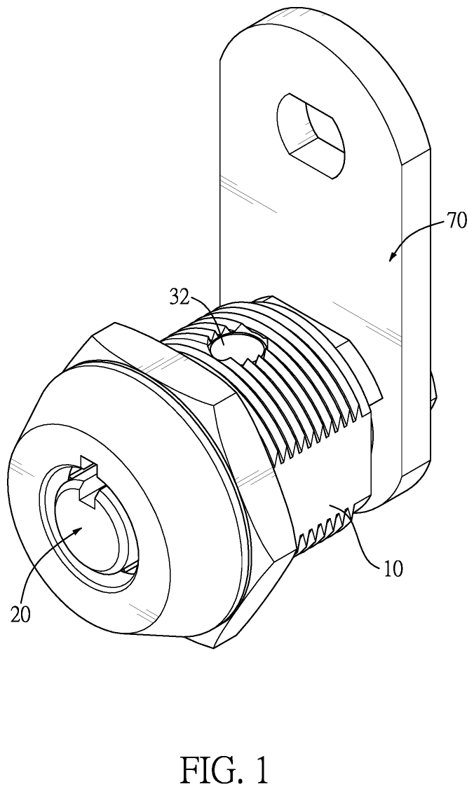

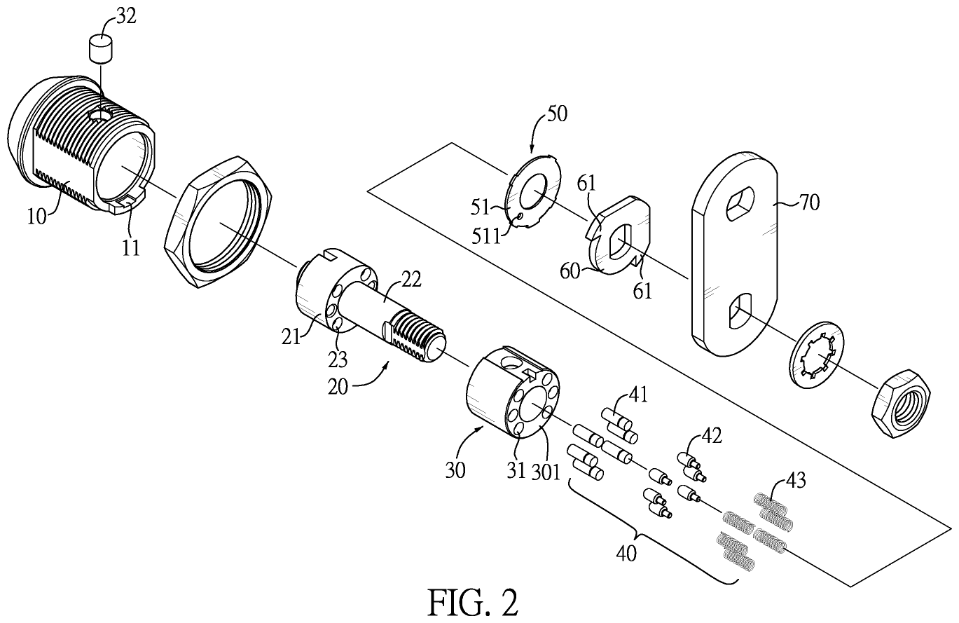

With reference to FIGS. 1 and 2, a first preferred embodiment of a tubular lock in accordance with the present invention comprises a housing 10, a lock core 20, a pin seat 30, multiple pin assemblies 40, a covering assembly 50, and a limiting ring 60.

The housing 10 is hollow and has a front portion, a rear portion, and a stop protrusion 11. The front portion and the rear portion are oppositely defined on the housing 10. The stop protrusion 11 protrudes from the rear portion of the housing 10.

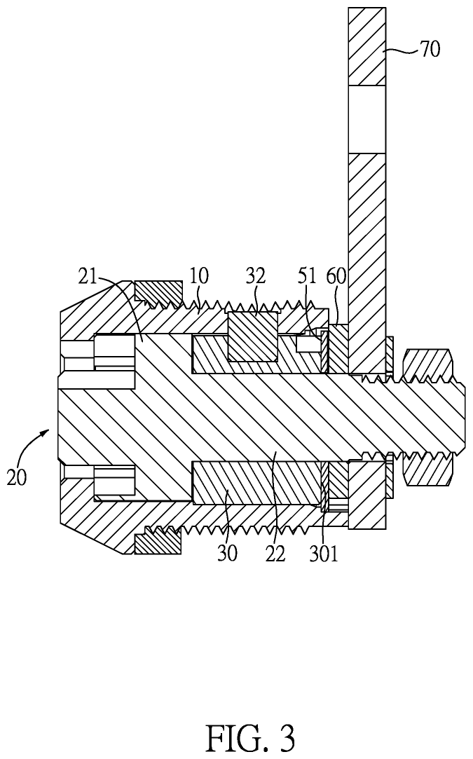

With further reference to FIG. 3, the lock core 20 is mounted in the housing 10 and has a head portion 21, a mounting portion 22, and multiple upper through holes 23. The head portion 21 corresponds in position to the front portion of the housing 10. The mounting portion 22 axially protrudes from a rear end face of the head portion 21 and toward the rear portion of the housing 10. A diameter of the mounting portion 22 is smaller than a diameter of the head portion 21. The mounting portion 22 protrudes out of the housing 10 for being assembled with a locking unit 70. The upper through holes 23 are separately formed through the head portion 21 and are arranged around the mounting portion 22. Each of the upper through holes 23 is defined through a front end face of the head portion 21 and the rear end face of the head portion 21.

In the first preferred embodiment as shown in FIGS. 1 to 3, the locking unit 70 may be a latch. Otherwise, the lock unit may be assembled with a switch, so as to form a key switch.

The pin seat 30 is mounted around the mounting portion 22 of the lock core 20 and is securely connected with the housing 10, such that the pin seat 30 is non-rotatable relative to the housing 10. The pin seat 30 has multiple lower through holes 31. The lower through holes 31 are separately formed through the pin seat 30, are arranged around the mounting portion 22, and align with the upper through holes 23 of the lock core 20 respectively. Each of the lower through holes 31 is defined through a front end face of the pin seat 30 and a rear end face 301 of the pin seat 30. The front end face of the pin seat 30 faces toward the rear end face of the head portion 21 of the lock core 20.

In the first preferred embodiment as shown in FIGS. 1 to 3, a fastening pin 32 is radially mounted through the housing 10 and is inserted into the pin seat 30, such that the housing 10 and the pin seat 30 are securely connected with each other.

Each of the pin assemblies 40 includes an upper pin 41, a lower pin 42, and a resilient element 43. The upper pins 41 of the pin assemblies 40 are mounted in the upper through holes 23 respectively. The lower pins 42 of the pin assemblies 40 are mounted in the lower through holes 31 respectively and are positioned toward the front end face of the pin seat 30. The resilient elements 43 of the pin assemblies 40 are mounted in the lower through holes 31 respectively and are positioned toward the rear end face 301 of the pin seat 30. Specifically, the resilient element 43 is a compression spring.

The covering assembly 50 is securely mounted in the rear portion of the housing 10 and covers the rear end face 301 of the pin seat 30, so as to cover the lower through holes 31 of the pin seat 30 and to prevent the resilient elements 43, the lower pins 42, and the upper pins 41 from dropping out of the pin seat 30.

With reference to FIGS. 2 and 3, in the first preferred embodiment, the covering assembly 50 includes a covering sheet 51 mounted around the mounting portion 22 and abutting against the rear end face 301 of the pin seat 30. An outer peripheral edge of the covering sheet 51 engages in an inner sidewall of the housing 10 such that the covering sheet 51 covers the lower through holes 31 of the pin seat 30.

The limiting ring 60 is disposed outside the rear portion of the housing 10, is securely mounted on the mounting portion 22 of the lock core 20, and has two limiting protrusions 61. The limiting protrusions 61 separately protrude radially from an outer peripheral edge of the limiting ring 60. The stop protrusion 11 of the housing 10 is disposed between the two limiting protrusions 61. Thus, when the lock core 20 rotates, a rotating angle of the lock core 20 can be limited with one of the limiting protrusions 61 abutting against the stop protrusion 11 of the housing 10.

Moreover, the covering sheet 51 further has at least one picking-proof hole 511 formed through the covering sheet 51. Each of the picking proof hole 511 aligns with one of the lower through holes 31. When someone tries to push the pin assemblies 40 from the front portion of the housing 10 with illegal unlocking tool, it is difficult to estimate the distances to push the pin assemblies 40. Therefore, as the lower pin 42 of the pin assembly 40 that corresponds in position to the picking-proof hole 511 is pushed to insert into the picking-proof hole 511, an intersection between the upper pin 41 and the lower pin 42 of the pin assembly 40 that corresponds in position to the picking-proof hole 511 is unable to correspond in position to an intersection between the head portion 21 and the pin seat 30. Accordingly, unlocking the tubular lock of the present invention with the illegal unlocking tool can be stopped.

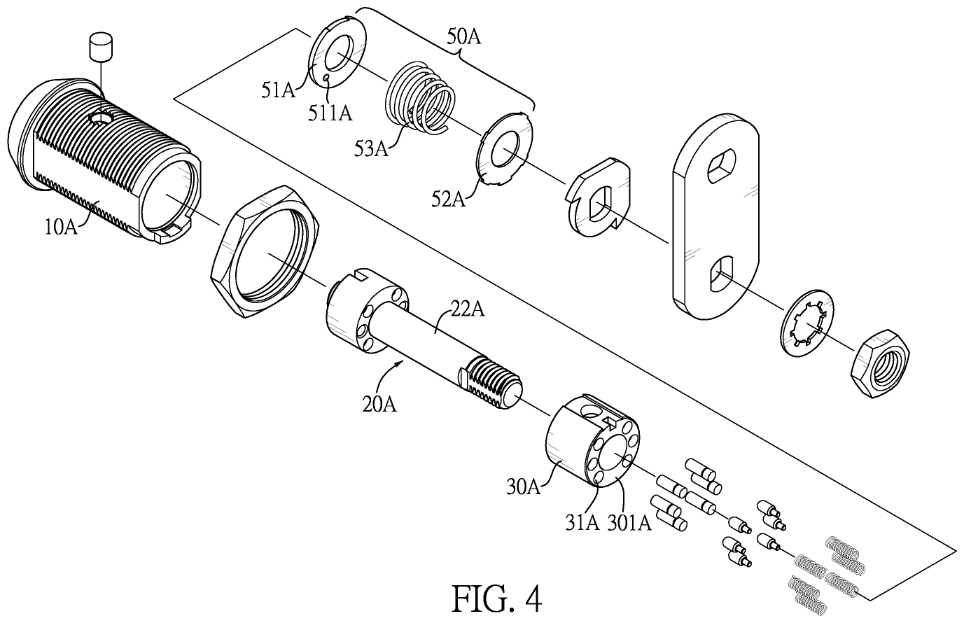

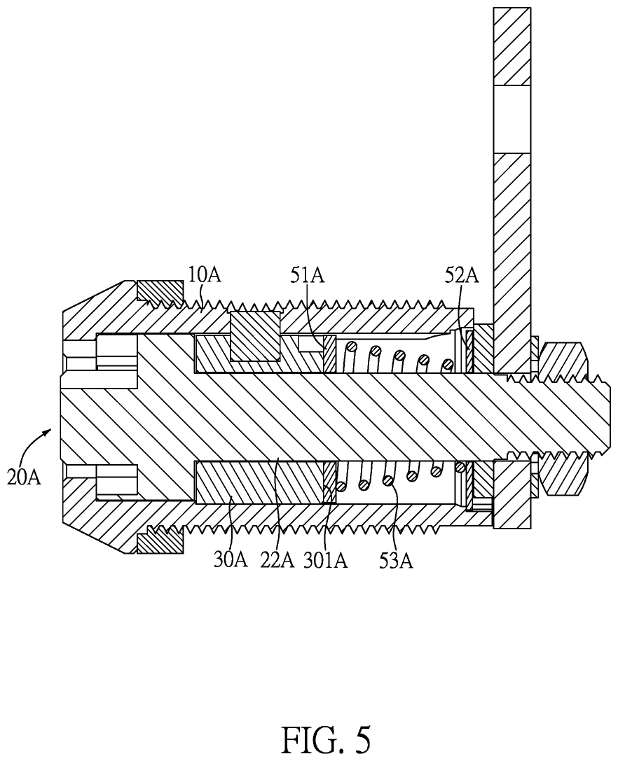

With reference to FIGS. 4 and 5, in a second preferred embodiment, the covering assembly 50A includes a covering sheet 51A, a stop sheet 52A, and a compression spring 53A. The covering sheet 51A is mounted around the mounting portion 22A of the lock core 20A and abuts against the rear end face 301A of the pin seat 30A to cover the lower through holes 31A of the pin seat 30A. The stop sheet 52A is mounted around the mounting portion 22A of the lock core 20A, is separated from the covering sheet 51A. An outer peripheral edge of the stop sheet 52A engages in the inner sidewall of the housing 10A. The compression spring 53A is mounted around the mounting portion 22A of the lock core 20A, and is disposed between and is compressed by the covering sheet 51A and the stop sheet 52A, such that the compression spring 53A pushes the covering sheet 51A to tightly abut against the rear end face 301A of the pin seat 30A and to cover the lower through holes 31A of the pin seat 30A. Moreover, the covering sheet 51A may further has at least one picking-proof holes 511A formed through the covering sheet 51A. The function of the at least one picking-proof holes 511A is the same as described above and therefore is omitted.

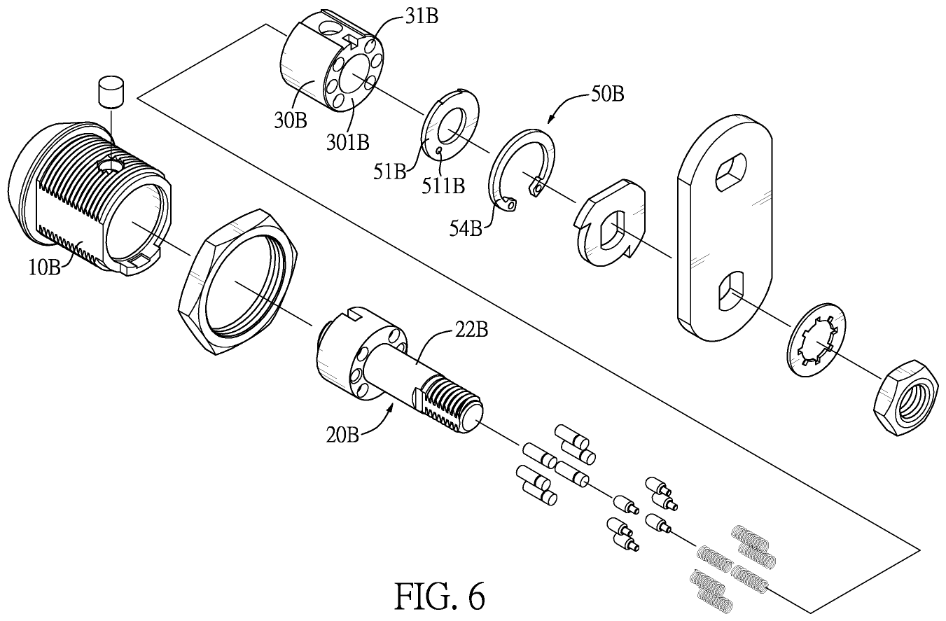

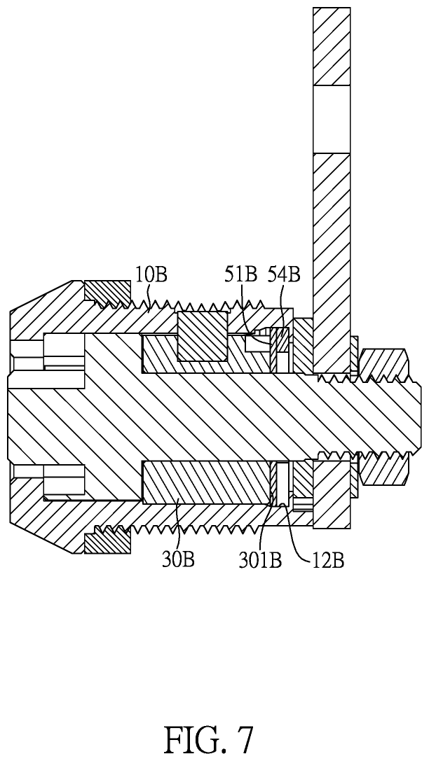

With reference to FIGS. 6 and 7, in a third preferred embodiment, the housing 10B has an annular engaging groove 12B formed in the inner sidewall of the housing 10B and disposed at the rear portion of the housing 10B. The covering assembly 50B includes a covering sheet 51B and a retaining ring 54B. The covering sheet 51B is mounted around the mounting portion 22B of the lock core 20B and abuts against the rear end face 301B of the pin seat 30B to cover the lower through holes 31B of the pin seat 30B. The retaining ring 54B is installed in the annular engaging groove 12B of the housing 10B. The covering sheet 51B is held between the retaining ring 54B and the pin seat 30B to cover the lower through holes 31B of the pin seat 30B.

Specifically, the retaining ring 54B may be a C-clip and can be pressed and resiliently deformed, so as to be put into the housing 10B. As the retaining ring 54B is released, the retaining ring 54B is restored to its original shape and engages in the annular engaging groove 12B of the housing 10B. Therefore, it is easy to install the retaining ring 54B.

Moreover, the covering sheet 51B may further has at least one picking-proof holes 511B formed through the covering sheet 51B. The function of the at least one picking-proof holes 511BA is the same as described above and therefore is omitted.

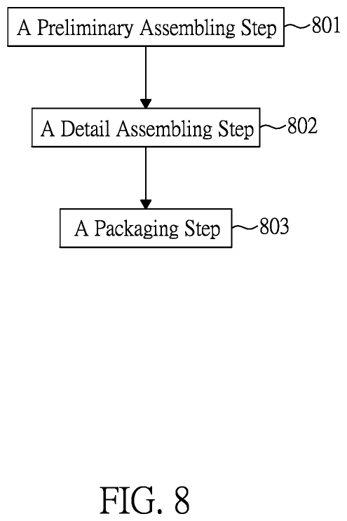

With reference to FIG. 8, a method for assembling the tubular lock comprises a preliminary assembling step 801, a detail assembling step 802, and a packaging step 803.

In the preliminary assembling step 801: mounting the pin seat 30, 30A, 30B around the mounting portion 22, 22A, 22B of the lock core 20, 20A, 2B, aligning the lower through holes 31, 31A, 31B of the pin seat 30, 30A, 30B with the upper through holes 23 of the lock core 20, 20A, 20B respectively, putting the lock core 20, 20A, 20B and the pin seat 30, 30A, 30B into the housing 10, 10A, 10B, and then inserting the fastening pin 32 through the housing 10, 10A, 10B and into the pin seat 30, 30A, 30B to securely connect the housing 10, 10A, 10B and into the pin seat 30, 30A, 30B.

In the detail assembling step 802: putting the upper pins 41, the lower pins 42, and the resilient elements 43 into the lower through holes 31, 31A, 31B and the upper through holes 23 from the rear end face 301, 301A, 301B of the pin seat 30, 30A, 30B, wherein the upper pins 41 are mounted in the upper through holes 23 of the lock core 20, 20A, 20B respectively, the lower pins 42 are mounted in the lower through holes 31 respectively and are positioned toward the front end face of the pin seat 30, 30A, 30B, and the resilient elements 43 are mounted in the lower through holes 31 respectively and are positioned toward the rear end face of the pin seat 30, 30A, 30B.

Specifically, an assembler may put the upper pins 41 of all of the pin assemblies 40, then put the lower pins 42 of all of the pin assemblies 40, and then put the resilient element 43 of all of the pin assemblies 40. Alternatively, the assembler may put the upper pin 41, the lower pin 42, and the resilient element 43 of one pin assembly 40 into the lower through hole 31, 31A, 31B and the upper through hole 23 that align with each other, and then put the upper pin 41, the lower pin 42, and the resilient element 43 of another pin assembly 40 into the lower through hole 31, 31A, 31B and the upper through hole 23 that align with each other. That is, the assembler may put the pin assemblies 40 one at a time.

In the packaging step 803: securely mounting the covering assembly 50, 50A, 50B in the rear portion of the housing 10, 10A, 10B to cover on the rear end face 301, 301A, 301B of the pin seat 30, 30A, 30B and to cover the lower through holes 31, 31A, 31B of the pin seat 30, 30A, 30B.

As shown in FIGS. 1 to 3, in the first preferred embodiment, the covering assembly 50 includes the covering sheet 51. Thus, in the packaging step 803, the covering sheet 51 is mounted around the mounting portion 22 of the lock core 20 and abuts against the rear end face 301 of the pin seat 30 to cover the lower through holes 31 of the pin seat 30, and the outer peripheral edge of the covering sheet 51 engages in the inner sidewall of the housing 10.

As shown in FIGS. 4 and 5, in the second preferred embodiment, the covering assembly 50A includes the covering sheet 51A, the stop sheet 52A, and the compression spring 53A. Thus, in the packaging step 803, the covering sheet 51A, the compression spring 53A, and the stop sheet 52A are sequentially mounted onto the mounting portion 22A of the lock core 20A with the outer peripheral edge of the stop sheet 52A engaging in the inner sidewall of the housing 10A to allow the compression spring 53A to push the covering sheet 51A to abut against the rear end face 301A of the pin seat 30A and cover the lower through holes 31A of the pin seat 30A.

As shown in FIGS. 6 and 7, in the third preferred embodiment, the covering assembly 50B includes the covering sheet 51B and the retaining ring 54B. Thus, in the packaging step 803, the covering sheet 51B is mounted around the mounting portion 22B of the lock core 20B and abuts against the rear end face 301B of the pin seat 30B, then the retaining ring 24B is pressed and resiliently deformed to be mounted into housing 10B, and then the retaining ring 54B is released and engages in the annular engaging groove 12B of the housing 10B to hold the covering sheet 51B between the retaining ring 54B and the pin seat 30B.

With the lower through holes 31, 31A, 31B formed through the front end face and the rear end face 301, 301A, 301B of the pin seat 30, 30A, 30B, the assembler is able to assemble the housing 10, 10A, 10B, the lock core 20, 20A, 20B, and the pin seat 30, 30A, 30B in the preliminary assembling step 801. Then the assembler puts the upper pins 41, the lower pins 42 and the resilient elements 43 of the pin assemblies 40 into the upper through holes 23 and the lower through holes 31, 31A, 31B from the rear end face 301, 301A, 301B of the pin seat 30, 30A, 30B in the detail assembling step 802. Afterwards, the assembler covers the lower through holes 31, 31A, 31B with the covering assembly 50, 50A, 50B in the packaging step 803.

During the assembling steps, the upper pins 41, the lower pins 42 and the resilient elements 43 do not fall from the upper through holes 23 and the lower through holes 31, 31A, 31B easily. Accordingly, the tubular lock of the present invention has simplified assembling steps and lowered difficulty of assembling. Even an inexperienced can also assemble the tubular lock quickly, and thus manufacturing cost of the tubular lock is lowered.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A tubular lock comprising:
a hollow housing;
a lock core mounted in the housing and having
a head portion;
a mounting portion axially protruding from a rear end face of the head portion and toward a rear portion of the housing; and
multiple upper through holes separately formed through the head portion and arranged around the mounting portion, and each of the upper through holes defined through a front end face of the head portion and the rear end face of the head portion;
a pin seat mounted around the mounting portion of the lock core, securely connected with the housing, and having multiple lower through holes, the lower through holes separately formed through the pin seat, arranged around the mounting portion, and aligning with the upper through holes of the lock core respectively, and each of the lower through holes defined through a front end face of the pin seat and a rear end face of the pin seat;
multiple pin assemblies, and each of the pin assemblies including
an upper pin mounted in the upper through holes respectively;
a lower pin mounted in the lower through holes respectively and positioned toward the front end face of the pin seat; and
a resilient element mounted in the lower through holes respectively and positioned toward the rear end face of the pin seat; and
a covering assembly securely mounted in the rear portion of the housing and covering the rear end face of the pin seat to cover the lower through holes of the pin seat.

2. The tubular lock as claimed in claim 1, wherein
the covering assembly includes a covering sheet mounted around the mounting portion and abutting against the rear end face of the pin seat; and
an outer peripheral edge of the covering sheet engages in an inner sidewall of the housing.

3. The tubular lock as claimed in claim 1, wherein the covering assembly includes
a covering sheet mounted around the mounting portion of the lock core and abutting against the rear end face of the pin seat to cover the lower through holes of the pin seat;
a stop sheet mounted around the mounting portion of the lock core, separated from the covering sheet, and having an outer peripheral edge engaging in an inner sidewall of the housing; and
a compression spring mounted around the mounting portion of the lock core, and disposed between and compressed by the covering sheet and the stop sheet.

4. The tubular lock as claimed in claim 1, wherein
the housing has an annular engaging groove formed in an inner sidewall of the housing and disposed at the rear portion of the housing; and
the covering assembly including
a covering sheet mounted around the mounting portion of the lock core and abutting against the rear end face of the pin seat to cover the lower through holes of the pin seat; and
a retaining ring installed in the annular engaging groove of the housing, wherein the covering sheet is held between the retaining ring and the pin seat.

5. The tubular lock as claimed in claim 2, wherein the covering sheet further has at least one picking-proof hole formed through the covering sheet, and each of the picking proof hole aligns with one of the lower through holes.

6. The tubular lock as claimed in claim 3, wherein the covering sheet further has at least one picking-proof hole formed through the covering sheet, and each of the picking proof hole aligns with one of the lower through holes.

7. The tubular lock as claimed in claim 4, wherein the covering sheet further has at least one picking-proof hole formed through the covering sheet, and each of the picking proof hole aligns with one of the lower through holes.

8. The tubular lock as claimed in claim 1, wherein
the housing has a stop protrusion protruding from the rear portion of the housing; and
the tubular lock further comprises a limiting ring disposed outside the rear portion of the housing, securely mounted on the mounting portion of the lock core and having two limiting protrusions separately protruding radially from an outer peripheral edge of the limiting ring, wherein the stop protrusion of the housing is disposed between the two limiting protrusions.

9. The tubular lock as claimed in claim 2, wherein
the housing has a stop protrusion protruding from the rear portion of the housing; and
the tubular lock further comprises a limiting ring disposed outside the rear portion of the housing, securely mounted on the mounting portion of the lock core and having two limiting protrusions separately protruding radially from an outer peripheral edge of the limiting ring, wherein the stop protrusion of the housing is disposed between the two limiting protrusions.

10. The tubular lock as claimed in claim 3, wherein
the housing has a stop protrusion protruding from the rear portion of the housing; and
the tubular lock further comprises a limiting ring disposed outside the rear portion of the housing, securely mounted on the mounting portion of the lock core and having two limiting protrusions separately protruding radially from an outer peripheral edge of the limiting ring, wherein the stop protrusion of the housing is disposed between the two limiting protrusions.

11. The tubular lock as claimed in claim 4, wherein
the housing has a stop protrusion protruding from the rear portion of the housing; and
the tubular lock further comprises a limiting ring disposed outside the rear portion of the housing, securely mounted on the mounting portion of the lock core and having two limiting protrusions separately protruding radially from an outer peripheral edge of the limiting ring, wherein the stop protrusion of the housing is disposed between the two limiting protrusions.

12. A method for assembling the tubular lock as claimed in claim 1 comprising:
a preliminary assembling step: mounting the pin seat around the mounting portion of the lock core, aligning the lower through holes of the pin seat with the upper through holes of the lock core respectively, putting the lock core and the pin seat into the housing, and then inserting the fastening pin through the housing and into the pin seat to securely connect the housing and into the pin seat;
a detail assembling step putting the upper pins, the lower pins, and the resilient elements into the lower through holes and the upper through holes from the rear end face of the pin seat; and
a packaging step securely mounting the covering assembly in the rear portion of the housing to cover on the rear end face of the pin seat and to cover the lower through holes of the pin seat.

13. The method as claimed in claim 12, wherein
the covering assembly includes a covering sheet; and
in the packaging step: mounting the covering sheet around the mounting portion of the lock core to allow the covering sheet to abut against the rear end face of the pin seat and to cover the lower through holes of the pin seat, and engaging an outer peripheral edge of the covering sheet in an inner sidewall of the housing.

14. The method as claimed in claim 12, wherein
the covering assembly includes a covering sheet, a stop sheet, and a compression spring; and
in the packaging step: mounting the covering sheet, the compression spring, and the stop sheet onto the mounting portion of the lock core sequentially with an outer peripheral edge of the stop sheet engaging in an inner sidewall of the housing to allow the compression spring to push the covering sheet to abut against the rear end face of the pin seat and cover the lower through holes of the pin seat.

15. The method as claimed in claim 12, wherein
the housing has an annular engaging groove formed in an inner sidewall of the housing and disposed at the rear portion of the housing;
the covering assembly includes a covering sheet and a retaining ring; and
in the packaging step: mounting the covering sheet around the mounting portion of the lock core to allow the covering sheet to abut against the rear end face of the pin seat, pressing the retaining ring to resiliently deform retaining ring and mounting the retaining ring into the housing, and then releasing the retaining ring to engage the retaining ring in the annular engaging groove of the housing to hold the covering sheet between the retaining ring and the pin seat.
